(19) United States
(12) Patent Application Publication
(10) Pub. No.: US 2021/0163261 A1
(43) Pub. Date: Jun. 3, 2021

(54) ELEVATOR SYSTEM HAVING A SERVICE VEHICLE FOR EXTRACTING AN ELEVATOR CAR

(71) Applicant: thyssenkrupp Elevator Innovation and Operations GmbH, Essen (DE)

(72) Inventors: Philippe GAINCHE, Großbettlingen (DE); Thomas KUCZERA, Leinfelden-Echterdingen (DE)

(73) Assignee: thyssenkrupp Elevator Innovation and Operations AG, Essen (DE)

(21) Appl. No.: 16/772,882

(22) PCT Filed: Dec. 18, 2018
(86) PCT No.: PCT/EP2018/085508

§ 371 Date: Jun. 15, 2020

(30) Foreign Application Priority Data
Dec. 29, 2017 (DE) 10 2017 131 449.0

(51) Int. Cl. B66B 5/00; B66B 9/00; B62B 3/10; B66B 11/04; B62B 5/00; B66B 19/00

(52) U.S. Cl. CPC B66B 5/0087; B66B 9/003; B66B 19/00; B66B 11/0407; B62B 5/0026; B62B 3/10

(57) ABSTRACT

An elevator system may include at least one elevator shaft, at least one elevator car that is displaceable in the at least one elevator shaft, and at least one service vehicle configured to receive an elevator car of the elevator system that is located at a stop floor. The elevator car may be displaced into the service vehicle along a direction of extraction perpendicular to a direction of extent of the at least one elevator shaft. Upon receiving the elevator car, the service vehicle may extract the elevator car from the at least one elevator shaft. A rotatable portion of a rail extending in the shaft along which the elevator car travels may be rotatable so as to align with a rail of the service vehicle.

The present invention relates to an elevator system having at least one elevator shaft and at least one elevator car which is displaceable in the at least one elevator shaft, as well as to a service vehicle for an elevator system, and to a method for extracting an elevator car from an elevator shaft of an elevator system.

### PRIOR ART

In elevator systems in which elevator cars are displaceable in an elevator shaft it may be desirable for individual elevator cars to be removed from the elevator shaft, for example in order for said elevator cars to be serviced at regular intervals or for defective elevator cars to be subjected to repair work.

For example, a transfer station for a ropeless elevator system in which elevator cars can be moved between elevator shafts and a parking region is known from WO 2016/109338 A1.

However, a transfer station of this type is complex in terms of construction and occupies a large installation space. It is desirable for an improved possibility to be provided for extracting an elevator car from an elevator shaft.

### DISCLOSURE OF THE INVENTION

Proposed according to the invention is an elevator system as well as a service vehicle for an elevator system and a method for extracting an elevator car from an elevator shaft of an elevator system, having the features of the independent patent claims. Advantageous design embodiments are the subject matter of the dependent claims as well as of the description hereunder.

The elevator system according to the invention has at least one elevator shaft and at least one elevator car which is displaceable in the at least one elevator shaft. Furthermore provided is at least one service vehicle which is specified for receiving an elevator car of the elevator system that is located in a stop floor, in that the elevator car in a direction of extraction perpendicular to a direction of extent of the at least one elevator car is displaced into the service vehicle. The service vehicle upon receiving the elevator car is furthermore specified for extracting the latter from the at least one elevator shaft. Protection is furthermore separately claimed for the service vehicle.

In the context of the method according to the invention, the elevator car in the elevator shaft is displaced into a stop floor and there in a direction of extraction perpendicular to a direction of extent of the elevator shaft is displaced into a service vehicle. The service vehicle upon receiving the elevator car extracts said elevator car from the at least one elevator shaft.

Preferred design embodiments and advantages of the elevator system according to the invention, of the service vehicle according to the invention, and of the method according to the invention are derived in a corresponding manner from the description hereunder.

The direction of extent of the at least one elevator shaft in this context is in particular to be understood to be that dimension in which the elevator shaft, or the elevator shafts, respectively, have in each case the largest extent thereof. It is to be understood that the elevator shaft, or the elevator shafts, respectively, likewise has/have extents in further dimensions, that is to say in directions which are perpendicular to said direction of extent. Said direction of extent is in particular a vertical direction, and the at least one elevator car herein is vertically displaceable in the at least one elevator shaft. It is likewise conceivable that the direction of extent is a horizontal direction and that the at least one elevator car herein is horizontally displaceable in the at least one elevator shaft. Elevator cars can be extracted in a particularly space-saving manner on account of the extraction perpendicular to the direction of extent of the at least one elevator shaft. The direction of extraction corresponds in particular to a direction of extent of the stop floor.

The extraction of the elevator car from the at least one elevator shaft in this context is in particular to be understood that the elevator car is completely removed from the elevator shafts of the elevator system and that all of the connections or couplings, respectively, between the elevator car and the elevator shafts are separated. The elevator car upon extraction thereof with the aid of the service vehicle can be moved in the stop floor or else from the stop floor independently of the elevator shafts. The extracted elevator car can be parked, serviced and/or repaired, for example. For this purpose, a special parking region or servicing region, respectively, to which the extracted elevator car can be moved with the aid of the service vehicle can be provided in the stop floor. It is also conceivable for the extracted elevator car to be introduced into a separate elevator system, for example in another building.

The elevator car, or the elevator cars, respectively, of the elevator system in particular have in each case one cabin and an elevator car frame which supports a cabin. An elevator car frame of this type is guided in particular by means of guides, for example roller guides, on the guide rails which are disposed in the at least one elevator shaft. The elevator cars expediently have in each case one slide which guides the elevator car frame on the guide rails. The slide can in particular be rotatable relative to the elevator car frame. Drive elements, for example parts of a linear drive, for displacing the elevator car in the at least one elevator shaft are expediently disposed on the slide.

A stop floor in this context is in particular to be understood to be a floor in a building comprising the elevator system to which the elevator cars in the course of regular transport procedures are displaced and where said elevator cars perform regular stops in the course of which passengers can enter or leave the elevator cars, for example. The at least one elevator car in the at least one elevator shaft is in particular displaceable along the direction of extent, expediently so as to carry out regular transport procedures of this type.

The building which comprises the elevator system can have an expedient number of floors. The stop floor in which the elevator car can be extracted herein can be a suitable one of said multiplicity of floors. It is to be understood that the stop floor can also be a maintenance level of the building, for example, to which access is allowed only to authorized personnel and in which maintenance and repair works are carried out on elevator cars, for example.

A plurality of service vehicles can in particular be provided in the stop floor so as to in each case receive one elevator car. At least one service vehicle can in each case expediently also be provided in a plurality of different stop floors. A plurality of elevator cars can thus in particular be extracted simultaneously from the at least one elevator shaft, on account of which a flexibility in terms of extracting elevator cars is increased.

On account of the invention, it is made possible for elevator cars to be extracted in a conventional stop floor of this type which is also served by the elevator cars of the elevator system in the course of regular transport procedures. It is thus in particular not necessary for additional stations or transfer stations, respectively, to be provided in the building comprising the elevator system so as to extract elevator cars at said stations or transfer stations, respectively. Installation space in the building can thus be saved, and elevator cars can be extracted in a simple manner with low complexity. It is in particular furthermore not necessary for elevator cars to first be displaced to an additional station or transfer station of this type, respectively, so as to extract said elevator cars at said additional station or transfer station, respectively. Instead, an elevator car can be extracted in the regular operation thereof, for example once said elevator car has anyway carried out a transport procedure to the stop floor and is already located in said stop floor. Elevator cars can thus be extracted in a flexible, uncomplicated manner.

It is to be understood that an extracted elevator car can expediently also be re-introduced into the at least one elevator shaft. For this purpose, the extracted elevator car in the stop floor is displaced in an analogous reversed manner in the direction of extraction from the service vehicle into the at least one elevator shaft.

For example, when a multiplicity of elevator cars are provided in the elevator system, it can be expediently selected, according to predefined criteria, which elevator car, or which elevator cars, respectively, are extracted. For example, when comparatively few transport procedures are carried out at times of low traffic and not all elevator cars are busy, one or a plurality of elevator cars which are not currently in use can be extracted, for example. When the number of transport procedures to be carried out thereafter increases during rush hours, the extracted elevator cars can be reintroduced in a flexible manner.

According to one preferred design embodiment the direction of extent of the at least one elevator shaft runs vertically and the direction of extraction runs horizontally. For extraction from the at least one elevator shaft, the elevator car in the stop floor is thus advantageously displaceable horizontally into the service vehicle. Displacing the elevator car horizontally in this manner enables installation space for extracting elevator cars to be saved, since it is in particular not necessary for a transfer station above or below a stop floor to be used, into which stop floor a cabin to be extracted can be displaced exclusively vertically.

The service vehicle advantageously has a rail, particularly preferably a horizontal rail, which runs in the direction of extraction and along which the elevator car in the direction of extraction is displaceable into the service vehicle. Running in the direction of extraction in this context is to be understood in particular that the rail has the largest extent thereof in the direction of extraction. It is to be understood that the rail likewise has extends in further dimensions, thus in directions perpendicular to the direction of extraction. Said rail interacts in particular with the elevator car, expediently with the slide of the elevator car, so as to displace said elevator car in the direction of extraction into the service vehicle. The elevator system has in particular a positioning system by means of which the service vehicle, or the rail thereof, respectively, in the stop floor can be positioned or oriented, respectively, relative to the at least one elevator shaft and/or relative to the elevator car to be extracted. This positioning or orienting is in particular performed in such a manner that the elevator car in the stop floor can interact with the rail of the service vehicle. A locking system by means of which the elevator car displaced into the service vehicle can be secured or fixed, respectively, to the service vehicle is furthermore expediently provided.

A rail, preferably a vertical rail, which runs in the direction of extent and along which the elevator car is displaceable in the at least one elevator shaft is preferably disposed in the at least one elevator shaft. In a manner analogous to the explanation above, running in the direction of extent in this context is to be understood that this rail possesses the largest extent thereof in particular in this direction of extent. Said rail is in particular configured as a guide rail on which the elevator car is guided by means of a guide, for example a roller guide. One rail of this type is in particular provided in each elevator shaft of the elevator system. The rail has a rotatable portion which is located in the stop floor and which from a first orientation parallel to the direction of extent, preferably a vertical orientation, is rotatable to a second orientation parallel to the direction of extraction, preferably a horizontal orientation. Said rotatable portion herein is in particular rotatable relative to a cabin of the elevator car. For this purpose, the slide of the cabin, or at least part of the slide, by means of which the elevator car frame is guided on the rail, is rotatable relative to the cabin, or relative to the elevator car frame, respectively. The elevator car is advantageously displaced along said rail in the elevator shaft into the stop floor, and the rotatable portion of the rail is preferably rotated from the first orientation to the second orientation. The elevator car thereafter is advantageously displaced along the rotatable portion in the second orientation, parallel to the direction of extraction, into the service vehicle.

The rotatable portion of the rail of the at least one elevator shaft in the second orientation of said rotatable rail is advantageously oriented so as to be parallel to and in alignment with the rail of the service vehicle. The service vehicle for extracting the elevator car is in particular oriented or positioned, respectively, relative to said rotatable portion, expediently in such a manner that the rail of the service vehicle and the rotatable portion in the second orientation thereof seamlessly adjoin one another.

The elevator car is preferably displaceable along the rotatable portion of the rail of the at least one elevator shaft in the second orientation of said rotatable portion, and along the rail of the service vehicle, into the service vehicle. For this purpose, the rotatable portion in the second orientation thereof and the rail of the service vehicle adjoin one another in a seamless manner, as explained above, such that the elevator car can be moved from the rotatable portion onto the rail of the service vehicle.

According to one preferred design embodiment the elevator car is displaceable along the rotatable portion of the rail in the second orientation of said rotatable portion in the direction of extraction between two elevator shafts of the elevator system. The elevator system in this case is advantageously configured as a so-called shaft-switching multi-cabin system in which elevator cars can switch between different elevator shafts. For this purpose, neighboring elevator shafts in the stop floor in particular have in each case a corresponding rotatable portion. When two rotatable portions of said neighboring elevator shafts are in each case rotated to the second orientation, the elevator car can expediently be displaced, preferably horizontally, along the direction of extraction between the two elevator shafts. The rotatable portions, besides switching the elevator cars between elevator shafts, can thus expediently likewise be used for extracting elevator cars.

Part of a linear drive is advantageously in each case disposed on the rail of the at least one elevator shaft and/or on the rail of the service vehicle, the elevator car by means of said linear drive being displaceable, in particular in a ropeless manner, thus in particular without suspension ropes or suspension belts. Said part of the linear drive which is disposed on the rails in particular interacts with a further part which is disposed on the elevator car, or on the slide of the latter. Energized coils are in particular disposed in each case on the rails as stators, or primary parts, of the linear drive, said coils interacting with permanent magnets and/or electromagnets which are disposed as reactive parts or secondary parts, respectively, of the linear drive on the elevator car, or on the slide thereof. Alternatively, permanent magnets and/or electromagnets can also be disposed as reactive parts or secondary parts, respectively, on the rails, and energized coils can be disposed on the elevator car as stators or primary parts, respectively. A design embodiment of the linear drive as an asynchronous linear drive which is configured without permanent magnets or electromagnets is furthermore conceivable.

The invention is particularly suitable for a so-called MULTI® elevator system of the applicant, in which a plurality of elevator cars by means of a linear motor drive can in each case be displaced in a mutually independent manner in one or a plurality of shaft portions. An elevator system of this type, having a plurality of elevator cars which can switch between shaft portions, is known from DE 10 2014 224 323 A1, for example.

According to one advantageous design embodiment, the service vehicle has a drive for displacement in the stop floor, for example an electric motor or a linear drive. The service vehicle by means of said drive is in particular displaceable along, or on the floor of, the stop floor, respectively. For this purpose, the service vehicle expediently has rollers or tires which can be directly driven by the drive, for example, or which can also serve as supports of the service vehicle, for example.

A control system is preferably provided and specified for controlling a movement of the service vehicle in the stop floor. An automatic displacement of the service vehicle in the stop floor can in particular be enabled by means of this control system. For this purpose, the control system can expediently interact with the drive of the service vehicle.

According to one advantageous design embodiment the service vehicle has at least one sensor which is specified for scanning floor markings in the stop floor. These sensors and these floor markings are in particular part of the control system. Paths or routes, respectively, may in particular be predefined by means of said floor markings, the service vehicle being able to be displaced along said paths or routes, respectively. These floor markings can be visual and/or magnetic markings in the floor of the stop floor, for example. The service vehicle can thus expediently automatically identify these floor markings and automatically follow the routes predefined by said markings.

A superordinate controller unit which, for example in a manner analogous to the explanations above, according to predefined criteria selects which elevator car, or which elevator cars, respectively, are to be extracted and which in particular furthermore determines to which special position in the stop floor said extracted elevator cars are to be transported can expediently be provided. When a plurality of service vehicles are provided in the stop floor, this control unit can expediently furthermore determine which of said service vehicles is used for extracting a special elevator car. The controller unit can in particular instruct said service vehicle in a corresponding manner, and transfer corresponding items of information such that said service vehicle with the aid of the control system can automatically receive the corresponding elevator car and automatically transport the latter to the envisaged position in the stop floor.

Further advantages and design embodiments of the invention are derived from the description and from the appended drawing

It goes without saying that the features mentioned above and those yet to be explained below can be used not only in the combination respectively indicated, but also in other combinations or by themselves, without departing from the scope of the present invention.

The invention is schematically illustrated in the drawings by means of an exemplary embodiment and will be described hereunder with reference to the drawing.

### DESCRIPTION OF THE FIGURES

In the drawing:

FIG. 1 schematically shows a preferred design embodiment of an elevator system according to the invention in a frontal view;

FIG. 2 schematically shows a preferred design embodiment of a service vehicle according to the invention in perspective views;

FIG. 3 schematically shows part of a preferred design embodiment of an elevator system according to the invention in perspective views; and

FIG. 4 schematically shows part of a preferred design embodiment of an elevator system according to the invention in a plan view.

### DETAILED DESCRIPTION OF THE DRAWING

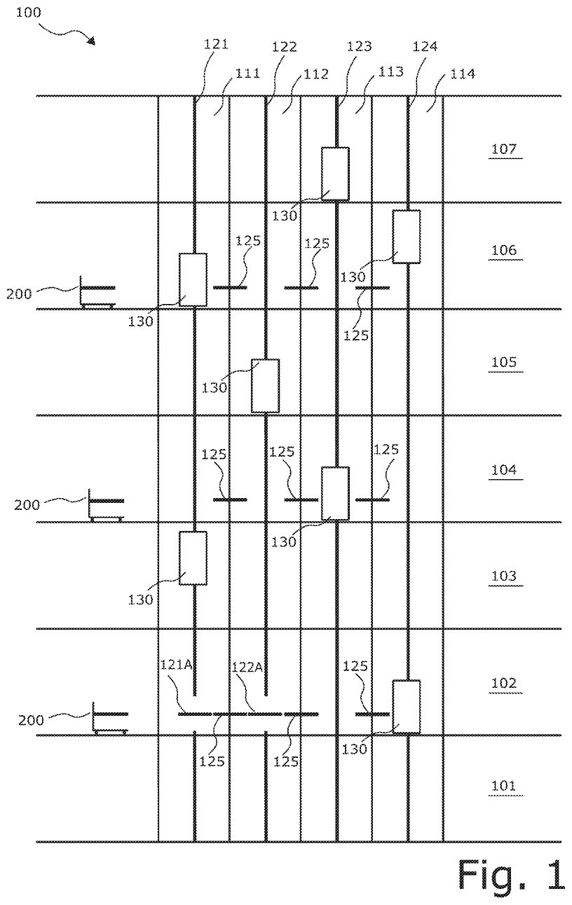

In the figures, identical reference signs refer to the same or equivalent elements. A preferred design embodiment of an elevator system according to the invention is schematically illustrated and identified by 100 in FIG. 1.

The elevator system extends across a multiplicity of floors in a building. For reasons of clarity, only seven floors 101, 102, 103, 104, 105, 106, 107 are shown in FIG. 1. It is however understood that the elevator system may also extend across a larger number of floors.

The elevator system 100 comprises a multiplicity of vertically running elevator shafts 111, 112, 113, 114. A direction of extent of the elevator shafts 111, 112, 113, 114 thus corresponds to a vertical direction.

Elevator cars 130 are in each case vertically displaceable in said elevator shafts 111, 112, 113, 114. For this purpose, rails 121, 122, 123, 124 are in each case provided in the elevator shafts 111, 112, 113, 114, energized coils being in each case provided on said rails 121, 122, 123, 124 as stators or primary parts, respectively, of a linear drive and interacting with electromagnets which are disposed on the elevator cars 130 as reactive parts or secondary parts, respectively, of the linear drive.

In the course of transport procedures, the elevator cars 130 are displaced within the elevator shafts 111, 112, 113, 114 and at the individual floors or stop floors 101, 102, 103, 104, 105, 106, 107, respectively, perform stops in the course of which the passengers of said elevator cars 130 can enter or leave the elevator cars 130.

The elevator system 100 is configured as a shaft-switching multi-cabin system in which elevator cars 130 can switch between the different elevator shafts 111, 112, 113, 114. For this purpose, the elevator cars 130 in special transfer floors 102, 104, 106 can be horizontally displaced between neighboring elevator shafts.

For this purpose, the rails 121, 122, 123, 124 in the special transfer floors 102, 104, 106 have in each case one rotatable portion which is in each case rotatable from a first vertical orientation to a second horizontal orientation. The rotatable portions 121A and 122A of the rails 121 and 122 in the transfer floor 102 in FIG. 1 are in each case illustrated in the second horizontal orientation of said rotatable portions 121A and 122A. The transfer floors 102, 104, 106 herein are also configured as stop floors to which the elevator cars 130 are also displaced in the course of regular transport procedures.

In order to switch between two neighboring elevator shafts, for example the shafts 111 and 112, an elevator car is vertically displaced to one of said transfer floors, for example to the floor 102. The corresponding rotatable portions 121A, 122A of the rails 121, 122 which are disposed in the elevator shafts 111, 112 are thereafter rotated from the first vertical to the second horizontal orientation of said rotatable portions 121A, 122A, as is illustrated in FIG. 1. The rotatable portions 121A, 122A in the second orientation thereof, conjointly with horizontal rail portions 125 which are disposed between the elevator shafts 111 and 112, form a horizontal rail along which the elevator car can be horizontally displaced between the two elevator shafts 111 and 112. Upon switching the elevator car 130 between the elevator shafts 111, 112, the rotatable portions 121A, 122A are rotated to the first vertical orientation thereof again.

Furthermore, elevator cars 130 can be extracted from the elevator shafts 111, 112, 113, 114 at said transfer floors 102, 104, 106, for example in order for said extracted elevator cars 130 to be serviced or to be repaired, or because said elevator cars 130 by virtue of low traffic are currently not required for carrying out transport procedures.

For this purpose, one service vehicle 200 or a multiplicity of service vehicles 200 is/are in each case provided in the transfer floors 102, 104, 106, said service vehicles 200 being in each case specified for receiving one elevator car 130 which is located in the respective transfer floor 102, 104, 106 in that said elevator car 130 is displaced in a direction of extraction perpendicular to the direction of extent of the elevator shafts 111, 112, 113 114 into the service vehicle 200. This direction of extraction in the present example corresponds to a horizontal direction. Upon receiving the elevator car 130, the latter by the service vehicle 200 is extracted from the elevator shafts 111, 112, 113, 114 and/or is displaced to a position remote from the elevator shafts 111, 112, 113, 114.

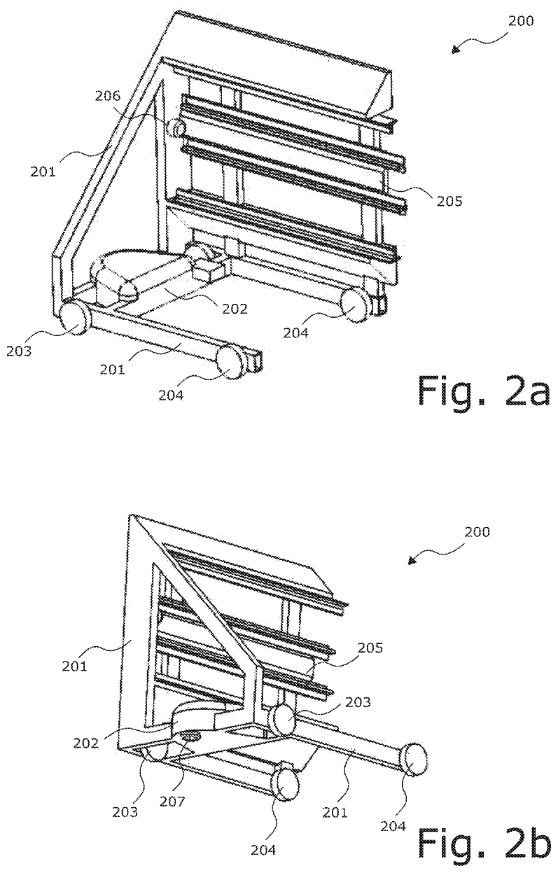

An extraction procedure of this type will be explained hereunder with reference to FIGS. 2 to 4.

A preferred design embodiment of a service vehicle 200 according to the invention is in each case schematically illustrated in a perspective view in FIGS. 2a and 2b.

The service vehicle 200 has a frame 201 as well as a drive 202, for example an electric motor. Two wheels 203 which are disposed on the frame 201 are actively driven by said drive 202. The service vehicle 200 has two further wheels 204 which are not actively driven and are disposed on the frame 201. Furthermore, one or a plurality of sensors 207 is/are disposed on the service vehicle 200.

The service vehicle furthermore has a rail 205 which runs in the direction of extraction, thus horizontally, and along which the elevator car 130 is displaceable in the direction of extraction, thus horizontally, into the service vehicle 200. In analogous manner to the rails 121, 122, 123, 124 in the elevator shafts 111, 112, 113, 114, energized coils are also disposed on this rail 205 of the service vehicle 200 as stators or primary parts, respectively, of a linear drive, said energized coils interacting with electromagnets which are disposed on the elevator cars 130 as reactive parts or secondary parts, respectively, of the linear drive. A locking system 206 is provided, by means of which the elevator car 130 displaced into the service vehicle 200 can be secured or fixed, respectively.

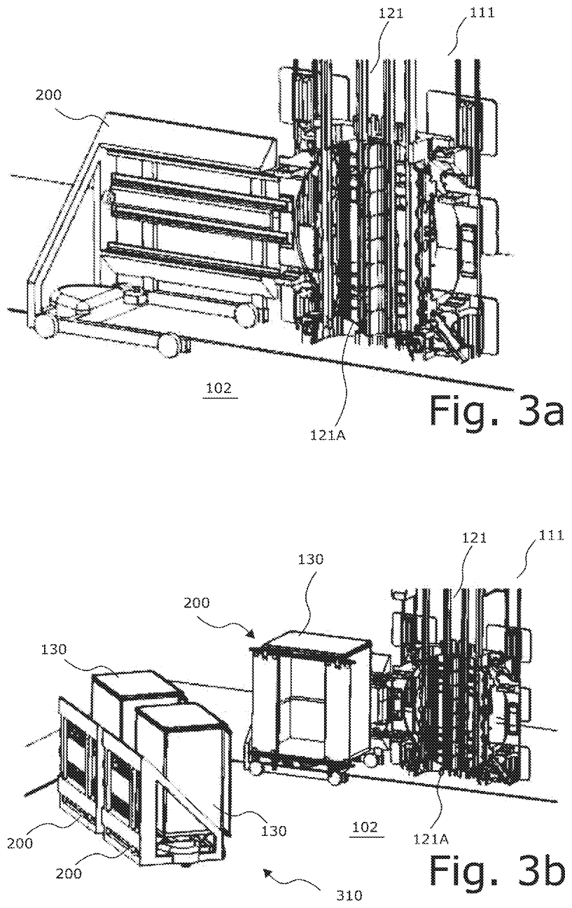

Part of the elevator system 100 from FIG. 1, specifically a fragment of the elevator shaft 111 in the stop floor or transfer floor 102, respectively, is in each case schematically illustrated in a perspective view in FIGS. 3a and 3b.

FIG. 3a shows this fragment prior to the extraction of an elevator car 130. For this purpose, one of the service vehicles 200 is displaced to the rail 121 of the elevator shaft 111 and oriented relative to the rotatable portion 121A of said rail 121. The service vehicle 200 herein is in particular oriented in such a manner that the rail 205 of the service vehicle 200 seamlessly adjoins the rotatable portion 121A when the rotatable portion 121A is located in the second horizontal orientation thereof.

In order for an elevator car 130 to be extracted, said elevator car 130 is first displaced along the rail 121 in the elevator shaft 111 into the stop floor 102. The rotatable portion 121A of the rail 121 is thereafter rotated from the first vertical orientation thereof to the second horizontal orientation thereof. The elevator car 130 is subsequently displaced along the rotatable portion 121A in the second orientation thereof, and displaced along the rail 205 of the service vehicle 200 into the latter. The elevator car 130 is fixed by means of the locking system 206. The rotatable portion 121A is thereafter rotated from the second horizontal orientation thereof to the first vertical orientation thereof.

This situation upon receiving the elevator car 130 in the service vehicle 200, is illustrated in FIG. 3. The elevator car 130 received by the service vehicle 200 is thereafter removed from the elevator shafts 111, 112, 113, 114 and with the aid of the service vehicle 200 in the stop floor 102 is transported to a parking region 310. Said parking region 310 is illustrated in FIG. 3b, wherein further elevator cars 130 have in each case already been extracted by means of a corresponding service vehicle 200.

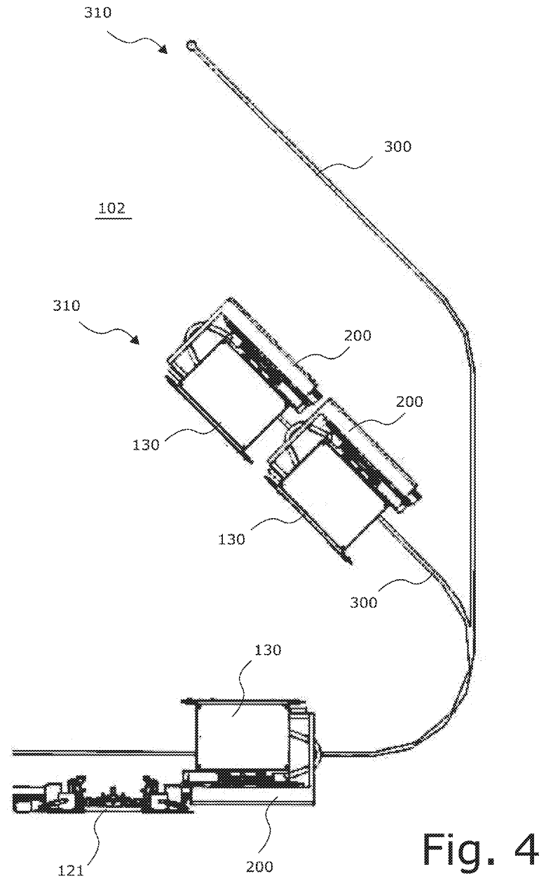

The fragment of the elevator system which is shown in a perspective view in FIG. 3b is schematically shown in a plan view in FIG. 4.

As is shown in FIG. 4, a control system for controlling movements of the service vehicles 200 in the stop floor 102 is provided. Said control system has floor markings 300 in the floor of the stop floor 102. These floor markings 300 can be scanned by sensors 207 which are disposed on the frame 201 of one of the service vehicles 200 such that the individual service vehicles 200 can sense their way on and orient themselves by said floor markings 300, and can thus be automatically displaced.

### LIST OF REFERENCE SIGNS

100 Elevator
101 to 107 Stop floors
111 to 114 Elevator shafts
121 to 124 Rails of the elevator shafts
121A, 122A Rotatable portion
125 Horizontal rail portion
130 Elevator
200 Service vehicle
201 Frame of the service vehicle
202 Drive of the service vehicle
203 Actively driven wheels of the service vehicle
204 Not actively driven wheels of the service vehicle
205 Rail of the service vehicle
206 Locking system
207 Sensor
300 Floor markings
310 Parking region

1.-14. (canceled)

15. An elevator system comprising:
an elevator shaft;
an elevator car that is displaceable in the elevator shaft; and
a service vehicle configured to receive the elevator car located in a stop floor, wherein the elevator car in a direction of extraction perpendicular to a direction of extent of the elevator shaft is configured to be displaced into the service vehicle, wherein upon receiving the elevator car the service vehicle is configured to extract the elevator car from the elevator shaft.

16. The elevator system of claim 15 wherein the direction of extent of the elevator shaft extends vertically, wherein the direction of extraction extends horizontally.

17. The elevator system of claim 15 comprising a rail disposed in the elevator shaft that extends in the direction of extent and along which the elevator car is displaceable in the elevator shaft, wherein the rail comprises a rotatable portion that is disposed at the stop floor and is configured to rotate from a first orientation parallel to the direction of extent to a second orientation parallel to the direction of extraction.

18. The elevator system of claim 15 wherein the service vehicle comprises a first rail that extends in the direction of extraction, the elevator car being displaceable along the first rail into the service vehicle, the elevator system further comprising a second rail disposed in the elevator shaft that extends in the direction of extent and along which the elevator car is displaceable in the elevator shaft, wherein the second rail comprises a rotatable portion that is disposed at the stop floor and is configured to rotate from a first orientation parallel to the direction of extent to a second orientation parallel to the direction of extraction, wherein the rotatable portion of the second rail in the second orientation is in alignment with the first rail of the service vehicle.

19. The elevator system of claim 18 wherein the elevator car is displaceable along the rotatable portion of the second rail in the second orientation and along the second rail into the service vehicle.

20. The elevator system of claim 18 wherein the shaft is a first shaft, the elevator system comprising a second shaft, wherein the elevator car is displaceable in the direction of extraction along the rotatable portion of the second rail in the second orientation of the rotatable portion between the first and second shafts.

21. The elevator system of claim 18 wherein part of a linear drive for displacing the elevator car is disposed on at least one of the first rail or the second rail.

22. The elevator system of claim 15 wherein the service vehicle comprises a rail that extends in the direction of extraction, the elevator car being displaceable along the rail into the service vehicle.

23. The elevator system of claim 15 wherein the service vehicle comprises a drive for displacement at the stop floor.

24. The elevator system of claim 23 comprising a control system for controlling movement of the service vehicle at the stop floor.

25. The elevator system of claim 15 wherein the service vehicle comprises a sensor for scanning floor markings at the stop floor.

26. A service vehicle for an elevator system that includes an elevator car that is displaceable in an elevator shaft, wherein the service vehicle is configured to receive the elevator car at a stop floor, wherein the elevator car is displaceable into the service vehicle in a direction of extraction perpendicular to a direction of extent of the elevator shaft, wherein upon receiving the elevator car the service vehicle is configured to extract the elevator car from the elevator shaft.

27. A method for extracting an elevator car from an elevator shaft of an elevator system, the method comprising:
displacing the elevator car in the elevator shaft to a stop floor;
displacing the elevator car into a service vehicle at the stop floor in a direction of extraction perpendicular to a direction of extent of the elevator shaft; and
extracting the elevator car from the elevator shaft with the service vehicle upon receipt of the elevator car in the service vehicle.

28. The method of claim 27 wherein the elevator car in the elevator shaft is displaced at the stop floor along a rail that extends in the direction of extent, wherein a rotatable portion of the rail located at the stop floor is rotated from a first orientation parallel to the direction of extent to a second orientation parallel to the direction of extraction, wherein the elevator car is displaced along the rotatable portion of the rail in the second orientation of the rotatable portion into the service vehicle.
